(19) United States
(12) Patent Application Publication
(10) Pub. No.: US 2005/0230184 A1
(43) Pub. Date: Oct. 20, 2005

(54) Safety harness system for hunters

(76) Inventor: Albert A. Ansaldo, San Antonio, CA (US)

Correspondence Address: DORR CARSON SLOAN & BIRNEY, PC, 3010 EAST 6TH AVENUE, DENVER, CO, 80206, US

(21) Appl. No.: 11/110,171

(22) Filed: Apr. 20, 2005

Related U.S. Application Data
(60) Provisional application No. 60/563,696, filed on Apr. 20, 2004.

(51) Int. Cl. A62B 35/00

(52) U.S. Cl. 182/3

(57) ABSTRACT

A safety harness system enables a hunter who has fallen out of a tree stand to either climb up or down the tree. An adjustable tether strap initially tethers the wearer to a tree strap secured around the tree. If the wearer falls, a foothold strap is deployed and its footholds used for support. The wearer attaches a second, recovery strap around the tree above or below the tree strap, and connects the tether strap to the recovery strap. The wearer shifts his weight from the tree strap to the recovery strap by loosening the tree strap. The tree strap is then repositioned around the tree above or below the recovery strap. The wearer shifts his weight back to the tree strap by loosening the recovery strap. The recovery strap is then repositioned above or below the tree strap. This process can be repeated as many times as necessary.

### RELATED APPLICATION

The present application is based on, and claims priority to the Applicant's U.S. Provisional Patent Application Ser. No. 60/563,696, entitled “Safety Harness System for Hunters,” filed on Apr. 20, 2004.

### BACKGROUND OF THE INVENTION

Field of the Invention. The present invention relates generally to the field of safety straps and harnesses. More specifically, the present invention discloses a system of straps and a harness for use by hunters with tree stands and the like.

Statement of the Problem. Many activities require a participant to take an elevated position on a tree or pole. For example, hunters and wildlife photographers sometimes position themselves in elevated tree stands many feet above the ground. Tree stands are well known in the field and a wide variety of tree stands are commercially available.

There is a significant risk of injury if the participant falls from the tree stand. As a result, various safety practices and equipment have been developed to reduce the risk of injury from such falls. In particular, tree stands are commonly equipped with a safety strap or tether strap that extends from a tree strap fastened around the tree to a belt or harness worn by the participant. In the event of a fall, the wearer will not fall to the ground, but rather only as far as the tether strap permits. Examples of such tether straps are disclosed in U.S. Pat. No. 5,738,046 (Williams et al.) and U.S. Patent Application Pub. No. 2002/0117353 (Jones) and 2003/0057018 (Dodson et al.).

However, this often leaves the wearer dangling from the tether strap in midair between the tree stand and the ground without a convenient way to either go up or down. Williams et al. attempt to address this problem by providing a second foothold strap that is attached to the tether strap. When not in use, the foothold strap is stowed in a small pouch on the tether strap above the wearer's head. The foothold strap has a series of stirrups or foot loops along its length that enable the wearer to climb up or down along the foothold strap. Nonetheless, the usefulness of this device is limited by the length of the foothold strap. Some tree stands are elevated up to 20 or 30 feet above the ground, which would require a foothold strap of substantial length with a large number of stirrups. Therefore, a need exists for a device that enables a wearer who has fallen out of a tree stand to recover by climbing up or down the tree, regardless of the elevation of the tree stand.

Solution to the Problem. The present invention addresses this problem by providing an additional recovery strap that can be fastened around the tree a few feet above or below the tree strap as a secondary point of support for connection to the tether strap attached to the wearer's harness. The wearer shifts his weight from the tree strap to the recovery strap by loosening the tree strap. The tree strap can then be removed and reattached around the tree a few feet above or below the recovery strap. The wearer shifts his weight back to the repositioned tree strap by loosening the recovery strap. The recovery strap is then repositioned around the tree a few feet above or below the tree strap. This process can be repeated as many times as necessary by alternately moving the tree strap and recovery strap to enable the wearer to climb up or down the tree.

### SUMMARY OF THE INVENTION

This invention provides a safety harness and system of straps that enable a hunter who has fallen out of a tree stand to either climb up or down the tree to safety. An adjustable tether strap initially tethers the wearer to a tree strap that has been secured around the tree. If the wearer falls from the tree stand, the tether strap and harness will limit the wearer's fall. The wearer can then deploy the foothold strap from its storage pouch and use its footholds for support. The wearer attaches a second, recovery strap around the tree a few feet above or below the tree strap, and connects the tether strap to the recovery strap. At this point, both the tree strap and the recovery strap are attached to the tether strap, but the wearer's weight is still carried by the tree strap. The wearer then shifts his weight from the tree strap to the recovery strap by loosening the tree strap. The tree strap can then be repositioned around the tree at a distance above or below the recovery strap. The wearer can then shift his weight back to the repositioned tree strap by loosening and repositioning the recovery strap around the tree at distance above or below the tree strap. This process can be repeated as many times as necessary by alternately moving the tree strap and recovery strap to enable the wearer to climb up or down the tree.

These and other advantages, features, and objects of the present invention will be more readily understood in view of the following detailed description and the drawings.

### BRIEF DESCRIPTION OF THE DRAWINGS

The present invention can be more readily understood in conjunction with the accompanying drawings, in which:

FIG. 1 is a front view of a hunter 20 wearing the safety harness 25.

FIG. 2 is a rear view of the hunter 20 wearing the safety harness 25 corresponding to FIG. 1.

FIG. 3 is a front view of the hunter 20 attaching one end of the recovery strap 60 to the front of the harness 25 in preparation for climbing a tree 10.

FIG. 4 is a side view of the hunter 20 climbing a tree 10 with the use of the recovery strap 60 attached across the front of the harness 25.

FIG. 5 is a front view of hunter 20 standing on a tree stand 15 with the tree strap 50 secured around the tree 10 and the adjustable tether strap 30 attached to the tree strap 50.

FIG. 6 is a front view after the hunter 20 has fallen from the tree stand 15 and is suspended by the tether strap 30. The hunter 20 has also deployed the foothold strap 40 from its storage pouch 34.

FIG. 7 is a detail view of foothold strap 40 and its storage pouch 34.

FIG. 8 is a detail view of the tree strap 50.

FIG. 9 is a detail view of the recovery strap 60.

FIG. 10 is a rear view of the hunter 20 suspended by the tether strap 30 with one foot in supported by the foothold strap 40, following FIG. 6.

FIG. 11 is a side view after the hunter has wrapped the recovery strap 60 around the tree 10 and attached it to the tether strap 30.

FIG. 12 is a side view showing the hunter 20 loosening the tree strap 50 to lower himself and shift his weight to the recovery strap 60.

FIG. 13 is a side view after the hunter 20 has removed the tree strap 50 from around the tree 10 and reattached it further down the tree 10 below the recovery strap 60.

### DETAILED DESCRIPTION OF THE INVENTION

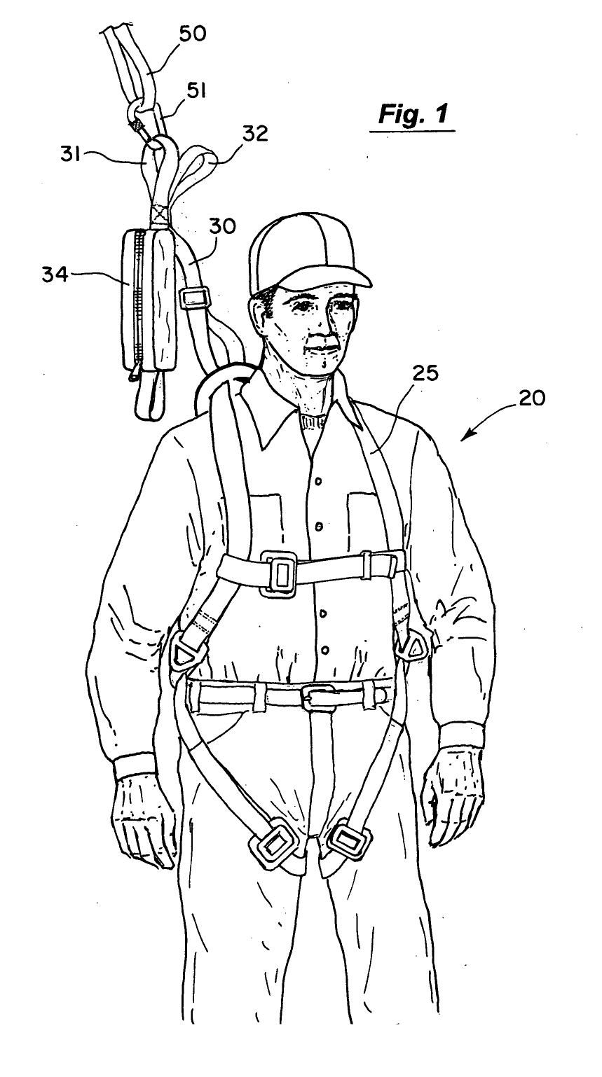

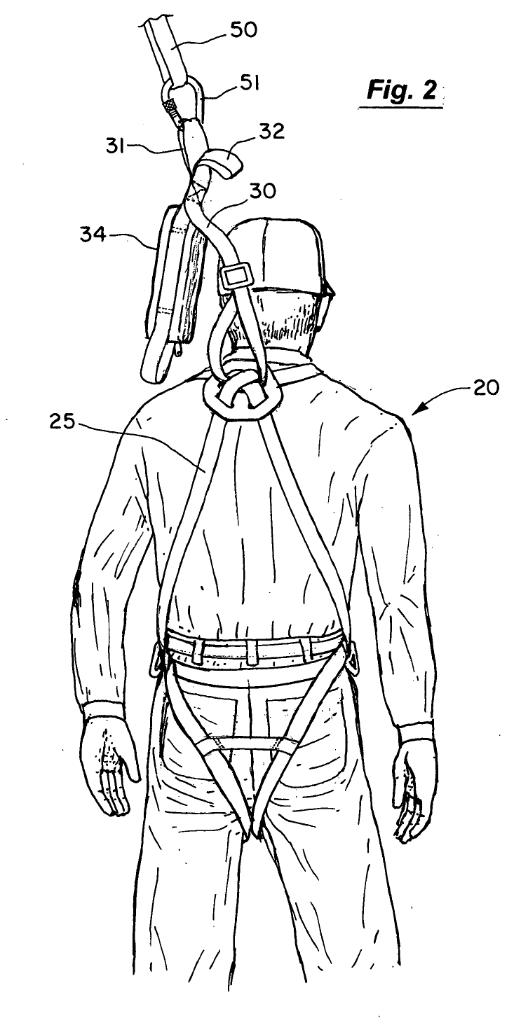

FIG. 1 is a front view of a hunter 20 wearing the safety harness 25. FIG. 2 is a corresponding rear view of the hunter 20 and safety harness 25. The safety harness 25 can be made in a conventional manner from a series of straps that support the hunter's torso and pelvis. A tether strap 30 is secured to the back of the harness 25 as shown in FIG. 2. The tether strap 30 has two loops 31, 32 formed in its distal end. Other types of connectors could be readily substituted for these loops 31, 32. The length of the tether strap 30 can be made adjusted by means of a buckle, for example.

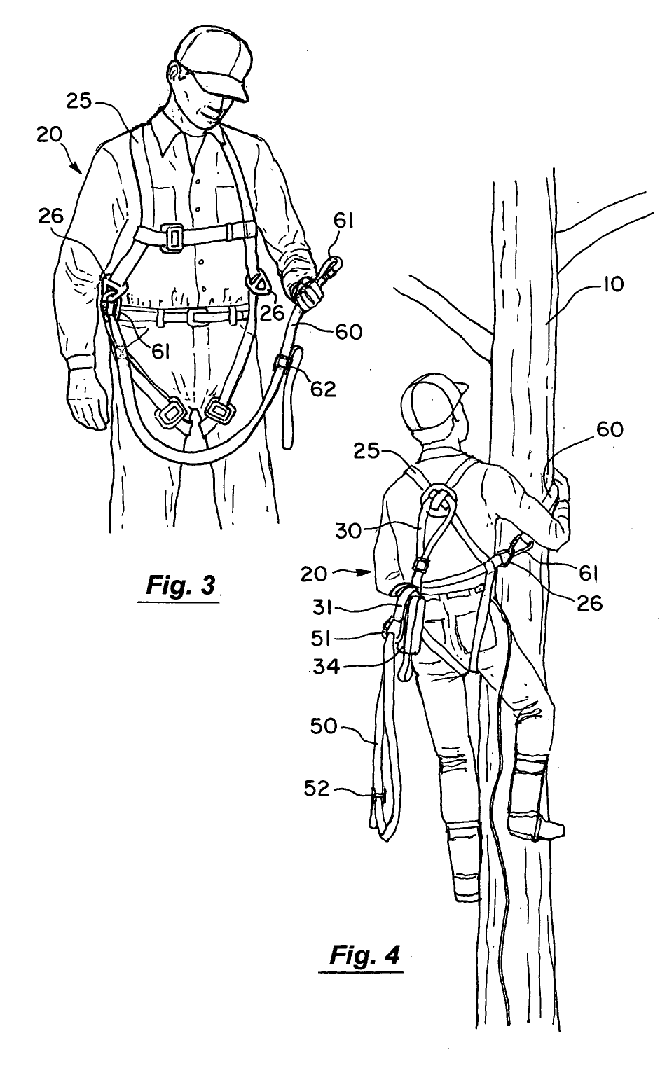

The present invention also includes a recovery strap 60 having a plurality of possible uses, as will be described below. The recovery strap 60 is shown in detail in FIG. 9. The recovery strap 60 has connectors 61 on both ends that can be removably secured to corresponding connectors 26 on the front or sides of the harness 25. FIG. 3 is a front view of the hunter 20 attaching one end of the recovery strap 60 to the front of the harness 25 in preparation for climbing a tree 10. This recovery strap 60 can be looped around the tree 10 to enable the hunter 20 to manually climb up the tree 10 in a manner similar to that used by a lineman to climb a telephone pole. FIG. 4 is a side view of the hunter 20 climbing a tree 10 with the use of the recovery strap 60 attached across the front of the harness 25 and around the tree 10. The recovery strap 60 and harness 25 allow the hunter 20 to lean backward to a degree and thereby support a portion of the hunter's weight during climbing. The hunter 20 typically uses his hands and feet to climb from foothold to foothold, or from branch to branch up the tree 10. The hunter periodically slides the recovery strap 60 upward or reattaches the recovery strap 60 at intervals as he climbs. Alternatively, the hunter 20 could climb up to the tree stand 15 by other conventional means, such as a ladder or rope, or by manually climbing the tree 10 without using the recovery strap 60.

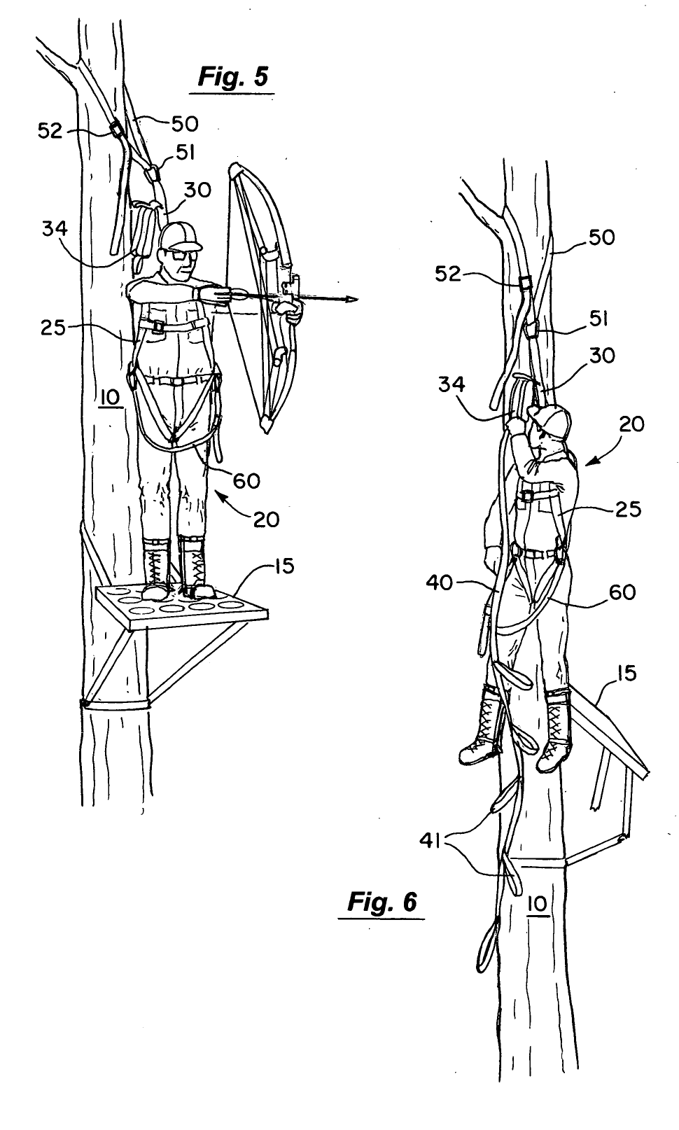

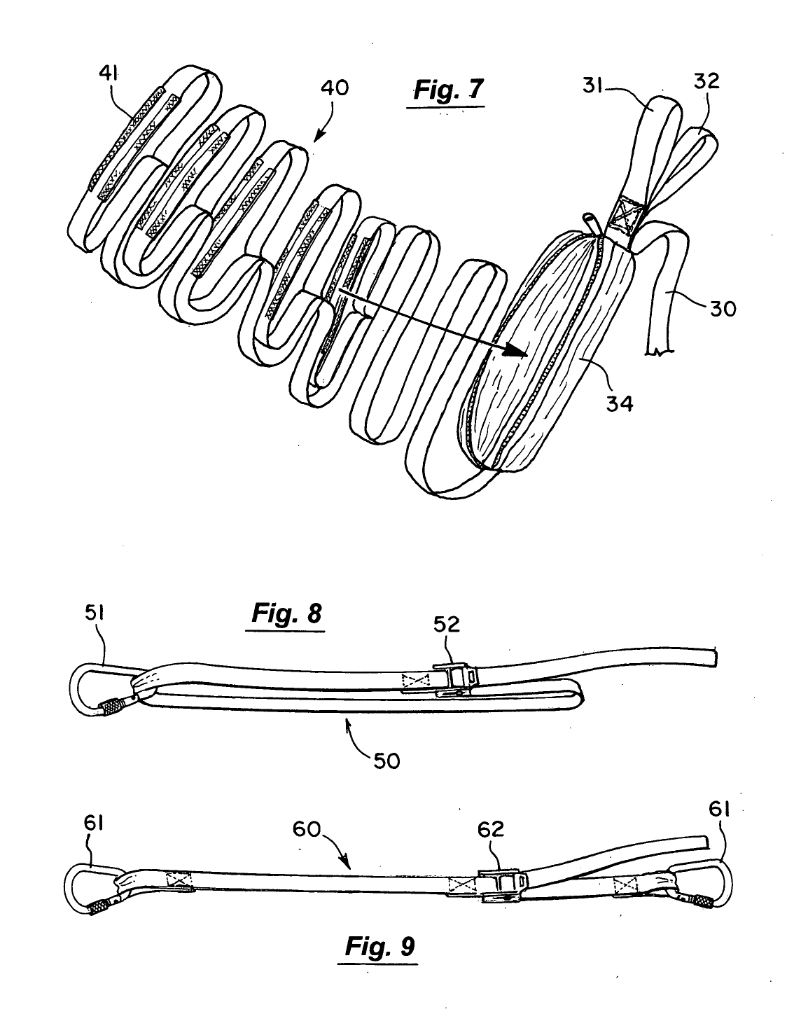

After climbing to the tree stand 15, the hunter should initially secure the upper, free end of the tether strap 30 to the tree 10. In the preferred embodiment of the invention, this is accomplished by wrapping the tree strap 50 around the tree 10, as shown for example in FIG. 5. FIG. 8 is a detail view of the tree strap 50. In particular, the tree strap 50 includes a connector 51 on at least one end of the tree strap 50, and a buckle 52 for adjusting the length of the tree strap 50.

FIG. 5 is a front view of the hunter 20 after he has attached the tether strap 30 from the harness 25 to the tree strap 50. The tree strap connector 51 has been removably attached to the first loop 31 on the end of the tether strap 30. The recovery strap 60 has been removed from around the tree 10 and can be stored at this point. Under normal conditions, the hunter 20 would remain standing on the tree stand 15 as shown in FIG. 5 while hunting.

In the preferred embodiment of the invention, the upper end of a foothold strap 40 is secured to the tether strap 30. This foothold strap 40 has a series of footholds 41 spaced at intervals along its length, as shown in FIGS. 6, 7 and 10-13. For example, the foothold strap 40 can have a length of approximately 20 feet. If the tree stand is sufficiently close to the ground, the hunter can simply drop the foothold strap 40, remove the harness 25, and descend safety to the ground. The foothold strap 40 can be folded and stored in a small pouch 34 on the tether strap 30 when it is not in use, as depicted in FIGS. 1, 2 and 7. Alternatively, the upper end of the foothold strap 40 could be attached to the harness 25 or the tree strap 50.

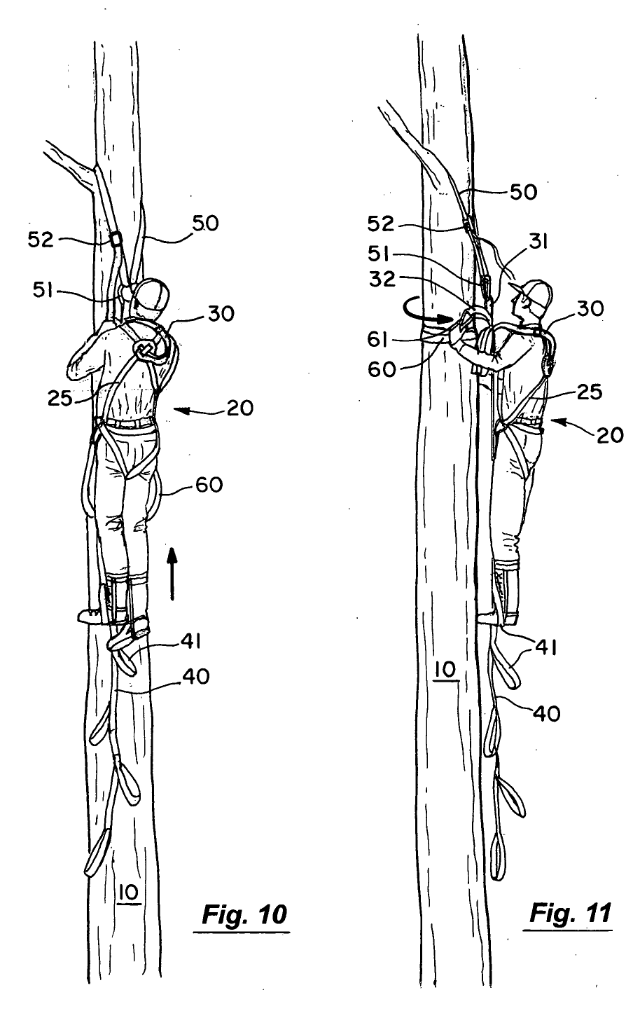

FIG. 6 is a front view after the hunter 20 has fallen from the tree stand 15. The hunter 20 is initially suspended from the tree 10 by the tether strap 30 and harness 25. At this point, the hunter 20 can reach up to release the foothold strap 40 from its storage pouch 34 on the tether strap 30, as depicted in FIG. 6. The foothold strap 40 will then drop downward so that the hunter can place his feet in the footholds 41 of the foothold strap 40, as shown in FIG. 10, and thereby shift his weight from the harness 25 to the foothold strap 40. The hunter 20 can climb up or down the foothold strap 40 by means of these footholds 41 to either return to the tree stand 15 or descend to the ground if the foothold strap 40 has sufficient length. However, the present invention is not limited to such situations, as will be described below.

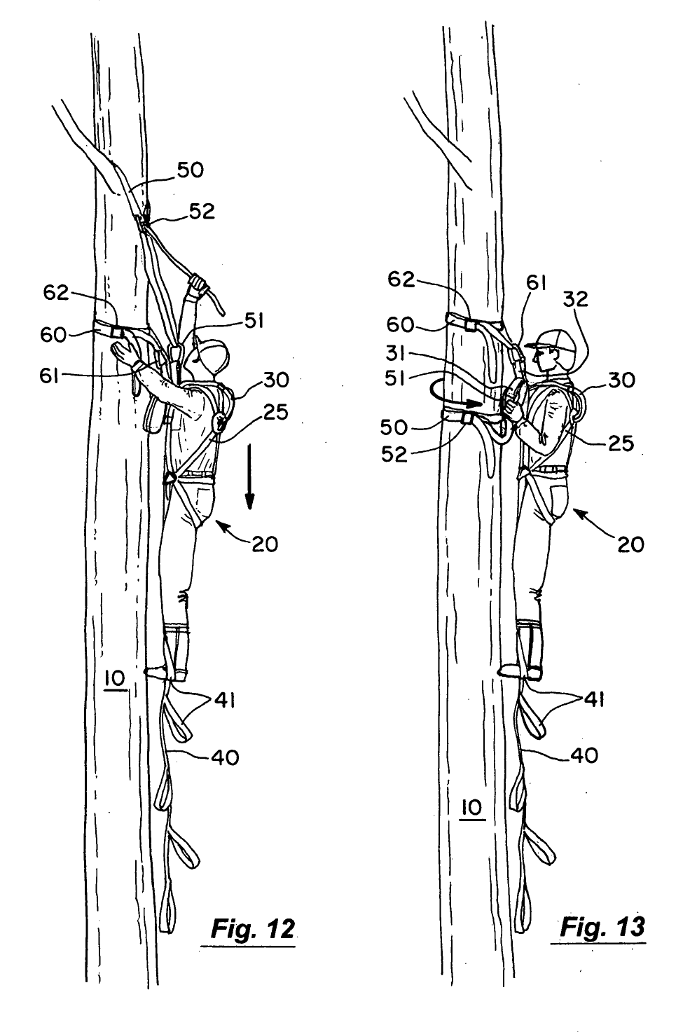

FIG. 11 is a side view after the hunter 20 has wrapped the recovery strap 60 around the tree 10 and attached it to the tether strap 30. The hunter wraps the recovery strap 60 around the tree 10 at an elevation either above or below the tree strap 50, depending on the hunter's intended direction of travel. (The remaining figures depict the hunter climbing down the tree 10 so the recovery strap 60 is attached below the tree strap 50 in FIG. 11.) The hunter 20 fastens at least one of the connectors 61 on the ends of the recovery strap 60 to the second loop 32 at the distal end of the tether strap 30. The hunter 20 can then loosen the tree strap 50 by means of its buckle 52 to gradually shift his weight from the tree strap 50 to the recovery strap 60, as illustrated in FIG. 12.

After the upper tree strap 50 has been loosened, it can be completely removed from around the tree 10 by the hunter 20. FIG. 13 is a corresponding side view after the hunter 20 has reattached the tree strap 50 further down the tree 10 below the recovery strap 60. After the tree strap 50 has been reattached to the tree, the hunter reconnects the tree strap 50 to the first loop 31 on the distal end of the tether strap 30, and then loosens the recovery strap 60 by means of its buckle 62 to shift the hunter's weight back to the tree strap 50.

After the recovery strap 60 has been loosened, it can removed from around the tree 10 and subsequently reattached further down the tree 10 beneath the tree strap 50. This process of alternately moving the tree strap 50 and recovery strap 60 in a step-wise fashion can be repeated as many times as necessary until the hunter 20 reaches the ground. In addition, the process can be reversed to enable the hunter 20 to climb up the tree 10.

It should be expressly understood that the term “strap” should be broadly construed in this invention to include ropes, cords, or lines of any type. In the preferred embodiment of the present invention, all of the straps are made of woven nylon. However, other materials could be readily substituted.

Optionally, a quick-release buckle can be included in the tether strap 30 (or between the tether strap 30 and the harness 25) to allow the hunter 20 to detach himself from the tether strap 30 without removing the harness 25. For example, this feature would allow the hunter to quickly climb down the foothold strap 40 and drop to the ground after the preceding method has been repeated to a point that the lower end of the foothold strap 40 has become reasonably close to the ground.

The above disclosure sets forth a number of embodiments of the present invention described in detail with respect to the accompanying drawings. Those skilled in this art will appreciate that various changes, modifications, other structural arrangements, and other embodiments could be practiced under the teachings of the present invention without departing from the scope of this invention as set forth in the following claims.

1. A safety harness system comprising:
a harness to be worn by a hunter;
a tether strap extending from the harness;
a tree strap having ends removably attachable to the tether strap to support a hunter from a tree by extending the tree strap around the a portion of a tree;
a foothold strap having at least one foothold and an upper end secured to the tether strap; and
a recovery strap having ends removably attachable to the tether strap to support a hunter from a tree by extending the recovery strap around a portion of a tree;
whereby a hunter can move along a tree by standing in the footholds of the foothold strap and alternatingly moving the tree strap and recovery strap in a step-wise fashion along the tree.

2. The safety harness system of claim 1 further comprising front connectors on the front of the harness to removable attachment of the recovery strap.

3. The safety harness system of claim 1 further comprising a storage pouch for storage of the foothold strap.

4. The safety harness system of claim 1 wherein the tether strap further comprises at least one loop for removable attachment of the tree strap and recovery strap.

5. The safety harness system of claim 1 wherein the tree strap further comprises a buckle allowing adjustment of the length of the tree strap.

6. The safety harness system of claim 1 wherein the recovery strap further comprises a buckle allowing adjustment of the length of the recovery strap.

7. The safety harness system of claim 1 wherein the tether strap further comprises a quick-release buckle to detach the harness.

8. The safety harness system of claim 1 wherein the foothold strap comprises a plurality of footholds at intervals along its length.

9. A safety harness system comprising:
a harness to be worn by a hunter;
a tether strap extending from the harness;
a tree strap having ends removably attachable to the tether strap to support a hunter from a tree by extending the tree strap around the a portion of a tree, said tree strap further having a buckle allowing adjustment of its length;
a foothold strap having a plurality of footholds at intervals along its length and upper end secured to the tether strap; and
a recovery strap having ends removably attachable to the tether strap to support a hunter from a tree by extending the recovery strap around a portion of a tree, said recovery strap further having a buckle allowing adjustment of its length;
whereby a hunter can move along a tree by standing in the footholds of the foothold strap, and alternatingly lengthening and then repositioning the tree strap and recovery strap in a step-wise fashion along the tree.

10. The safety harness system of claim 9 further comprising front connectors on the front of the harness to removable attachment of the recovery strap.

11. The safety harness system of claim 9 further comprising a storage pouch for storage of the foothold strap.

12. The safety harness system of claim 9 wherein the tether strap further comprises at least one loop for removable attachment of the tree strap and recovery strap.

13. The safety harness system of claim 9 wherein the tether strap further comprises a quick-release buckle to detach the harness.

14. The safety harness system of claim 9 wherein the foothold strap comprises a plurality of footholds at intervals along its length.

15. A method for enabling a hunter who has fallen out of a tree stand to climb along a tree to safety, said method comprising:
providing the hunter with
(a) a harness worn by the hunter:
(b) a tether strap extending from the harness;
(c) a tree strap having ends removably attachable to the tether strap to support the hunter from a tree by extending the tree strap around the a portion of a tree;
(d) a foothold strap having at least one foothold and an upper end secured to the tether strap; and
(e) a recovery strap having ends removably attachable to the tether strap;
placing the hunter's feet in the footholds of the foothold strap so that the hunter's weight is carried by the tether strap and the tree strap;
positioning the recovery strap around a portion of the tree a distance from the tree strap and attaching the ends of the recovery strap to the tether strap;
shifting the hunter's weight from the tree strap to the recovery strap by loosening the tree strap;
repositioning the tree strap around a portion of the tree a distance from the recovery strap;
shifting the hunter's weight from the recovery strap to the tree strap by loosening the recovery strap; and
repositioning the recovery strap around a portion of the tree a distance from the tree strap.

16. The method of claim 15 wherein the recovery strap further comprises a buckle allowing adjustment of its length, and wherein the recovery strap is loosened by lengthening the recovery strap.

17. The method of claim 15 wherein the tree strap further comprises a buckle allowing adjustment of its length, and wherein the tree strap is loosened by lengthening the tree strap.
